(19) United States
(12) Patent Application Publication
(10) Pub. No.: US 2026/0089740 A1
(43) Pub. Date: Mar. 26, 2026

(54) METHOD FOR WIRELESS COMMUNICATION, AND ELECTRONIC DEVICE AND COMPUTER-READABLE STORAGE MEDIUM

(71) Applicant: Sony Group Corporation, Tokyo (JP)

(72) Inventor: Tingting FAN, Beijing (CN)

(73) Assignee: Sony Group Corporation, Tokyo (JP)

(21) Appl. No.: 19/138,121

(22) PCT Filed: Dec. 18, 2023
(86) PCT No.: PCT/CN2023/139405

§ 371 Date: Jun. 12, 2025

(30) Foreign Application Priority Data
Dec. 22, 2022 (CN) 202211655903.4

(51) Int. Cl. H04W 72/232; H04W 52/02

(52) U.S. Cl. CPC H04W 72/232; H04W 52/0235

(57) ABSTRACT

The present disclosure relates to a method for wireless communication, and an electronic device and a computer-readable storage medium. The electronic device according to the present disclosure comprises a processing circuit, the processing circuit being configured to: scramble first downlink control information (DCI) by using a predefined terminal identifier, so as to instruct a terminal device to decode second DCI in a set of specified control channels; and send the scrambled first DCI to the terminal device.

This application claims priority to Chinese Patent Application No. 202211655903.4 titled “METHOD FOR WIRELESS COMMUNICATION, AND ELECTRONIC DEVICE AND COMPUTER-READABLE STORAGE MEDIUM”, filed on Dec. 22, 2022 with the China National Intellectual Property Administration (CNIPA), which is incorporated herein by reference in its entirety.

### FIELD

The present disclosure relates to the technical field of wireless communication, and in particular to a method and electronic device for wireless communication and a computer-readable storage medium which are beneficial to reducing a power consumption for control channel monitoring on a terminal device side.

### BACKGROUND

Downlink Control Information (DCI) is for scheduling authorization and scheduling allocation of a terminal device (User Equipment, UE). The DCI is carried by a Physical Downlink Control Channel (PDCCH) and is transmitted from a network side to the UE.

In order to obtain the DCI carried by the PDCCH, the UE performs blind detect on the PDCCH from a search space (SS) where the PDCCH may be sent, that is, attempts to de-scramble the PDCCH by using a designated terminal identifier (such as a Cell-RadioNetwork TemporaryIdentifier, (C-RNTI)). The UE may perform a next operation if valid control information, such as scheduling grant, is found. The search space is a concept proposed in the New Radio (NR) standard in order to limit the maximum number of blind decoding attempts by the UE while introducing as few restrictions as possible to the scheduler. A search space is a set of candidate PDCCHs composed of Control-Channel Elements (CCEs) preconfigured by the network side. Multiple search spaces may be pre-configured on the network side.

Although the search space is introduced, the UE performs blind detect on the PDCCH from all the search space, unless otherwise specified. Therefore, a power consumption for control channel monitoring on the user equipment side is high.

### SUMMARY

Hereinafter provided is a brief summary of the present disclosure, which is intended to provide a basic understanding of aspects of the present disclosure. It should be understood, however, that this summary is not an exhaustive overview of the present disclosure. The summary is not intended to identify key or critical portions of the present disclosure or to delineate the scope of the disclosure. The purpose is merely to present some concepts about the present disclosure in a simplified form, as a prelude to the more detailed description that is presented later.

An objective of embodiments of the present disclosure is to provide a method and an electronic device for wireless communication and a computer-readable storage medium, with which a power consumption for control channel monitoring on a UE side can be reduced by designating a reduced range of blind detection of control channel for a UE.

According to an embodiment of the present disclosure, an electronic device is provided. The electronic device includes processing circuitry. The processing circuitry is configured to: scramble a first downlink control information, DCI, with a predefined terminal identifier, to indicate that a terminal device decodes a second DCI in a designated set of control channels; and transmit the scrambled first DCI to the terminal device.

According to another embodiment of the present disclosure, an electronic device is provided. The electronic device includes processing circuitry. The processing circuitry is configured to: receive a first downlink control information DCI scrambled with a predefined terminal identifier; and decode a second DCI in a designated set of control channels according to indication of the terminal identifier.

According to a further embodiment of the present disclosure, a method for wireless communication is provided. The method includes: scrambling a first downlink control information, DCI, with a predefined terminal identifier, to indicate that a terminal device decodes a second DCI in a designated set of control channels; and transmitting the scrambled first DCI to the terminal device.

According to another embodiment of the present disclosure, a method for wireless communication is provided. The method includes: receiving a first downlink control information DCI scrambled with a predefined terminal identifier; and decoding a second DCI in a designated set of control channels according to indication of the terminal identifier.

According to another aspect of the present disclosure, a non-transitory computer-readable storage medium storing executable instructions is provided. The executable instructions, when executed by a processor, cause the processor to perform the method for wireless communication or functions of the electronic device.

According to other aspects of the present disclosure, computer program codes and a computer program product for implementing the above-described method according to the present disclosure are further provided.

According to at least one aspect of an embodiment of the present disclosure, the first DCI is scrambled with a predefined terminal identifier to indicate that the UE decodes the second DCI in a designated set of control channels. In this way, a range of blind detection of control channel is reduced for the UE, which is beneficial to reducing a power consumption of control channel monitoring on the UE side. In addition, the first DCI is scrambled with a predefined terminal identifier so that a reduced set of control channels is implicitly indicated for the second DCI. Such implicit indication does not require modification on a format of the first DCI or additional indication information to be carried by a payload of the first DCI. Hence, it is beneficial to compatibility with existing signaling and reduce of a signaling overhead.

Other aspects of the embodiments of the present disclosure are set forth in the following sections of the specification, where the detailed description is provided to fully disclose preferred embodiments of the embodiments of the present disclosure, rather than to impose limitations thereon.

### BRIEF DESCRIPTION OF THE DRAWINGS

The accompanying drawings described herein are only for illustrative purposes of selected embodiments, rather than all possible embodiments, and are not intended to limit the scope of the present disclosure. In the drawings:

FIG. 1 is a block diagram showing a first configuration example of an electronic device on a base station side according to an embodiment of the present disclosure;

FIG. 2 is a schematic diagram showing an example of first DCI and second DCI transmitted according to an embodiment of the present disclosure;

FIG. 3 is a block diagram showing a second configuration example of an electronic device on a base station side according to an embodiment of the present disclosure;

FIG. 4 is a block diagram showing a configuration example of an electronic device on a terminal side according to an embodiment of the present disclosure;

FIG. 5 is a flowchart illustrating example signaling interactions for transmitting and decoding DCI according to an embodiment of the present disclosure;

FIG. 6 is a flowchart illustrating a process example of a method for wireless communication on a base station side according to an embodiment of the present disclosure;

FIG. 7 is a flowchart illustrating a process example of a method for wireless communication on a terminal side according to an embodiment of the present disclosure;

FIG. 8 is a block diagram showing a first example of a schematic configuration of an eNB to which the technology of the present disclosure may be applied;

FIG. 9 is a block diagram showing a second example of a schematic configuration of an eNB to which the technology of the present disclosure may be applied;

FIG. 10 is a block diagram showing an example of a schematic configuration of a smart phone to which the technology of the present disclosure is applicable;

FIG. 11 is a block diagram showing an example of a schematic configuration of a car navigation device to which the technology of the present disclosure may be applied.

Although the present disclosure is easily subjected to various modifications and replacements, specific embodiments thereof, as examples, are shown in the drawings and described in detail here. However, it should be understood that, the description of specific embodiments herein is not intended to limit the present disclosure to specific forms that are disclosed. On the contrary, an object of the present disclosure is to cover all modifications, equivalents and replacements that fall within the spirit and scope of the present disclosure. It should be noted that throughout the several drawings, corresponding components are indicated by corresponding reference numerals.

### DETAILED DESCRIPTION

Examples of the present disclosure are now fully described with reference to the accompanying drawings. The following description is merely substantially exemplary and is not intended to limit the present disclosure, an application or use thereof.

Exemplary embodiments are provided so that the present disclosure is described in detail and fully conveys the scope thereof to those skilled in the art. Examples of specific components, apparatus, methods and other specific details are set forth to provide detailed understanding of embodiments of the present disclosure. It will be apparent to those skilled in the art that the exemplary embodiments may be implemented in many different forms without the use of specific details, and they should not be construed as limiting the scope of the present disclosure. In some exemplary embodiments, well-known processes, well-known structures, and well-known technologies are not described in detail.

The description is given in the following order.
1 Overview
2. Configuration Example of Electronic Device on Base Station Side
   2.1 First Configuration Example
   2.2 Second Configuration Example
3. Configuration Example of Electronic Device on Terminal Side
4. Signaling Process Example
5. Method Embodiment
6. Application Example

### 1 Overview

As mentioned above, although the concept of search space is introduced in the NR standard to limit the maximum number of attempts for blind decoding by a UE, unless otherwise specified, the UE blindly detect PDCCH from all search spaces, resulting in high power consumption of the UE for control channel monitoring.

In view of the above problem, the inventor proposes the following inventive concept. According to the inventive concept, one or more terminal identifiers (predefined terminal identifiers) for designating a set of candidate control channels for blind decoding for a terminal device are predefined, and a first DCI is scrambled with such terminal identifier to indicate that the UE decodes the second DCI in the designated set of control channels. In this way, the range of blind detection or monitoring by the UE is reduced to the designated set of control channels indicated by the terminal identifier, that is, reduced to a subset of control channels of the overall search space. In this way, the reduced set of control channels is implicitly indicated, which is not only conducive to reducing a power consumption of the UE for control channel monitoring, but also conducive to compatibility with existing signaling and reduce of a signaling overhead.

More specifically, the “predefined terminal identifier” proposed in the present disclosure is a predefined terminal identifier for designating a set of candidate control channels for blind decoding for a terminal device. The predefined terminal identifier may be, for example, a predetermined scrambling code having a predetermined length, and is a new terminal identifier different from any existing terminal identifier. A specific form of the predefined terminal identifier, such as a specific scrambling code, is not limited in the present disclosure, as long as the predefined terminal identifier is distinguishable from an existing terminal identifier such as existing RNTIs.

According to the present disclosure, devices on the base station side or the terminal side may obtain relevant information (such as definition information or description information) of a predefined terminal identifier in various appropriate manners. The information may, for example, indicate the scrambling code of each terminal identifier and the purpose of the terminal identifier for indicating a designated set of control channels for decoding subsequent DCI (“second DCI”) for the terminal device. Such relevant information may be written to a storage unit of the device on the base station side or the terminal side with delivery from the factory, hardwired to the above device, or otherwise pre-stored in the storage unit of the device through other manners, and thereby be obtained by the devices on the base station side or the terminal side. Alternatively, the device on the base station side may obtain the relevant information of the predefined terminal identifier in advance through one of the above manners, and then transmit the information to the device on the terminal side. The manner in which the device on the base station side and or the terminal side obtains the relevant information of the predefined terminal identifier is not specifically limited in the present disclosure, and is not described in detail here.

Next, apparatuses and methods and example signaling procedures according to embodiments of the present disclosure are further described with reference to the accompanying drawings.

### 2. Configuration Example of Electronic Device on Base Station Side

### 2.1 First Configuration Example

FIG. 1 is a block diagram showing a first configuration example of an electronic device on a base station side according to an embodiment.

As shown in FIG. 1, the electronic device 100 may include a scrambling unit 110 and a communication unit 120. In addition, although not shown in the drawing, the electronic device 100 may further include a storage unit.

Here, units of the electronic device 100 may be included in processing circuitry. It should be noted that the electronic device 100 may include a single processing circuit or multiple processing circuits. Further, the processing circuitry may include various discrete functional units for performing various different functions and/or operations. It should be noted that these functional units may be physical entities or logical entities, and units with different names may be implemented by a same physical entity.

According to an embodiment of the present disclosure, the scrambling unit 110 of the electronic device 100 may be configured to: scramble a first downlink control information, DCI, with a predefined terminal identifier, to indicate that a terminal device (UE) decodes a second DCI in a designated set of control channels. The communication unit 120 of the electronic device 100 may be configured to transmit the first DCI scrambled with the predefined terminal identifier to the terminal device (UE). Alternatively, the communication unit 120 may be further configured to transmit a second DCI to the UE after transmitting the scrambled first DCI, so that the UE receiving the first DCI decodes the second DCI in a designated set of control channels according to the indication of the predefined terminal identifier scrambling the first DCI.

In addition, although not shown in the figure, the electronic device 100 may further include a configuration unit. For example, the configuration unit may pre-configure multiple search spaces by configuring, for each search space, a DCI format to be monitored, an aggregation level of PDCCH (i.e., the number of continuous CCEs usable for the PDCCH, such as 1, 2, 3, 8 or 16), the number of PDCCH candidates at each aggregation level, and the like. As an example, the electronic device 100 may pre-configure 10 search spaces, which are represented by search space identifiers (SS id) 0 to 9. In this case, the electronic device 100 scrambles the first DCI with the predefined terminal identifier through the scrambling unit 110, so as to indicate to the UE that the second DCI is decoded in a designated set of control channels in all the search spaces (for example, all the 10 search spaces with SS ids 0 to 9).

As mentioned above, one or more terminal identifiers may be predefined for designating a set of candidate control channels for blind decoding for the terminal device, and the electronic device 100 on the base station side and the UE on the terminal side may obtain relevant information (such as definition information or description information) of the terminal identifiers in advance through various appropriate manners.

For example, a first terminal identifier may be predefined for scrambling the first DCI including a wake-up indication (such as the first DCI as a wake-up signal DCI (WUS DCI)) to indicate that a subsequent second DCI is to be decoded in a designated set of control channels. The first terminal identifier uses a scrambling code different from an existing PS-RNTI for scrambling the WUS DCI and indicating transmission power saving information, and may be named, for example, a new PS-RNTI.

In addition to indicating the scrambling code of the terminal identifier and the purpose, which is particularly concerned by the present disclosure, of the terminal identifier for indicating a designated set of control channels for decoding subsequent DCI (“second DCI”) for the terminal device, the related information (such as definition information or description information) of the predefined first terminal identifier further indicates a basic purpose that the terminal identifier is for indicating transmission of power-saving information, that is, scrambling the DCI (such as WUS DCI) including a wake-up indication. Thereby, on receipt of the WUS DCI scrambled with the first terminal identifier, the UE performs an activation operation and blindly detects the second DCI using the designated set of control channels when DRX ON (discontinues reception wake-up) starts.

In addition, a second terminal identifier may be predefined for scrambling the first DCI including no wake-up indication (such as DCI other than WUS DCI) to indicate that a subsequent second DCI is to be decoded in a designated set of control channels. The second terminal identifier may be named, for example, a monitoring reduction RNTI (MR-RNTI). The relevant information (such as definition information or description information) of a predefined second terminal identifier may simply indicate the scrambling code of the terminal identifier and the purpose of the terminal identifier for indicating a designated set of control channels for decoding subsequent DCI (“second DCI”) for the terminal device.

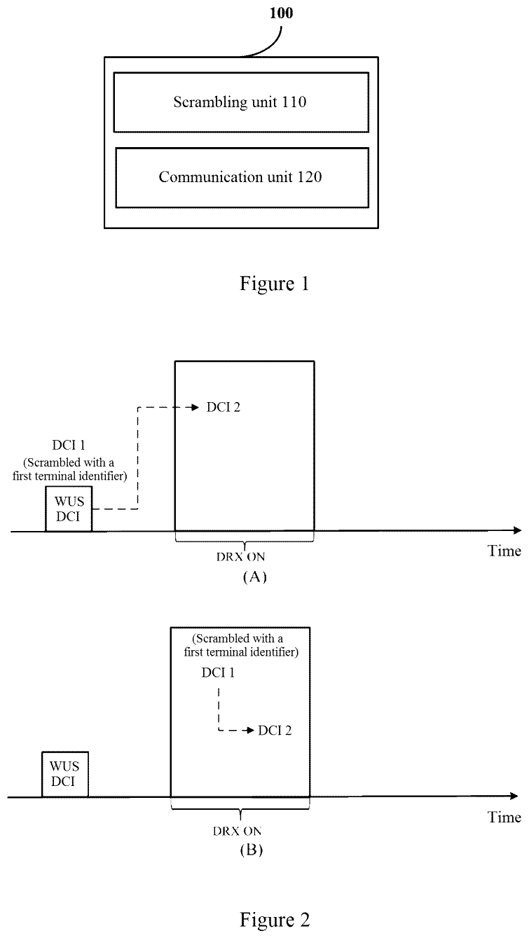

In an example, the first DCI includes a wake-up indication (for example, the first DCI is the WUS DCI), the terminal identifier utilized by the scrambling unit 120 to scramble the first DCI is the above-mentioned first terminal identifier. In another example, the first DCI includes no wake-up indication (for example, the first DCI is DCI other than the WUS DCI), the terminal identifier utilized by the scrambling unit 120 to scramble the first DCI is the above-mentioned second terminal identifier. In FIG. 2, (A) schematically shows an example in which DCI 1 as WUS DCI is scrambled with the first terminal identifier to indicate a set of control channels for decoding DCI 2, and (B) schematically shows an example in which DCI 1 as non-WUS DCI is scrambled with the second terminal identifier to indicate a set of control channels for decoding DCI 2. As shown in FIG. 2, such implicit indication method does not occupy the payload of DCI 1 or change a format of DCI 1, and the implicit indication is transmitted simultaneously with DCI 1. Therefore, the signaling overhead is reduced without affecting the DCI signaling format, an efficiency is improved, and a latency is reduced.

In an implementation, the predefined terminal identifier (such as but not limited to the above-mentioned first terminal identifier or second terminal identifier) may be directly defined to be associated with a designated set of control channels, and more specifically may be associated with a condition satisfied by a designated set of control channels. In this case, in addition to indicating the scrambling code of the terminal identifier and the purpose of the terminal identifier for indicating a designated set of control channels for decoding subsequent DCI for the terminal device, the relevant information of the predefined terminal identifier obtained by the device on the base station side or the terminal side through various appropriate manners may further indicate a condition satisfied by a set of control channels associated with the terminal identifier. Since the association between the terminal identifier and the condition satisfied by the set of control channels is directly designated in the relevant information obtained in advance by the base station side or the terminal side, it is beneficial to further reduce of the signaling overhead.

As an example, a condition that the designated set of control channels satisfies or meets may include but is not limited to: a first condition that the control channels in the set have the same DCI format as the first DCI; a second condition that the control channels in the set have the same aggregation level as a control channel carrying the first DCI; a third condition that the control channels in the set have the same search space identifier as a control channel carrying the first DCI; or a fourth condition that the control channels in the set have a scheduling DCI format. Although further description is given below in conjunction with the first to fourth conditions as examples, the condition satisfied by the designated set of control channels in the present disclosure is not limited thereto, but as long as a subset of all candidate control channels (all search spaces) can be designated to narrow a range of blind detection by the UE, which is not described in detail here.

For example, the first terminal identifier for scrambling DCI including a wake-up indication may be predefined to be associated with the fourth condition that “the control channels in the set have a scheduling DCI format”.

Generally, after the electronic device 100 on the base station side transmits the first DCI as the WUS DCI to the UE, for example via the communication unit 120, the UE is woken up, and the electronic device 100 then transmits the second DCI for scheduling to the UE. Correspondingly, the electronic device 100 may utilize the scrambling unit 110 to scramble the WUS DCI with the first terminal identifier, which is associated with the fourth condition and for indicating transmission of the power-saving information, and thereby activate the UE and indicate that the UE searches for the subsequent second DCI directly in the PDCCH having the scheduling DCI format when DRX ON starts.

In the pre-configured search space, a small SS id may be configured for a common search space (CSS), and a large SS id may be configured for a UE-specific search space (USS). During the blind detection in all search spaces, the UE performs the blind detection in an order of the SS ids from small to large. That is, a PDCCH candidate included in a search space having a small SS id is decoded first, and a PDCCH candidate included in a search space having a large SS id is decoded later. However, in a case where the DCI is scheduled as a detection target, detecting the CSS first results in wasted energy consumption and a reduced efficiency of the blind detection. Therefore, by scrambling the DCI including a wake-up indication using the first terminal identifier associated with the fourth condition that “control channels in the set has a scheduling DCI format”, a PDCCH candidate in a non-scheduling DCI format is excluded from the range of the blind detection by the UE. In this way, the power consumption of the blind detection by the UE is significantly reduced compared to blind detection in the overall search space, and the efficiency of blind detection is improved.

Similarly, the second terminal identifier for scrambling DCI including no wake-up indication may be predefined to be associated with the fourth condition that “the control channels in the set have a scheduling DCI format”.

Hence, in a case where the first DCI is DCI other than WUS DCI (such as scheduling DCI), as the second DCI to be transmitted is scheduling DCI, the electronic device 100 may utilize the scrambling unit 110 to scramble the first DCI with the second terminal identifier associated with the fourth condition, indicating that the UE searches directly in the PDCCH having the scheduling DCI format. Scrambling to indicate such association may be particularly beneficial in some applications. For example, in an application related to Extended Reality (XR), after DRX ON starts, during data scheduling after XR traffic arrives, the electronic device 100 on the base station side may transmit a large amount of scheduling DCI. In this case, by scrambling the DCI including no wake-up indication (such as a previous scheduling DCI) using the second terminal identifier associated with the fourth condition that “control channels in the set has a scheduling DCI format”, a PDCCH candidate in a non-scheduling DCI format is excluded from the range of the blind detection by the UE. In this way, the power consumption of the blind detection by the UE is significantly reduced, and the efficiency of blind detection is improved.

In addition, alternatively, for example, the second terminal identifier for scrambling DCI including no wake-up indication may be predefined to be associated with the first condition that “the control channels in the set have the same DCI format as the first DCI”.

Hence, in a case where the first DCI is DCI other than WUS DCI (such as scheduling DCI), as the second DCI to be transmitted has the same DCI format as the first DCI, the electronic device 100 may utilize the scrambling unit 110 to scramble the first DCI with the second terminal identifier associated with the first condition, indicating that the UE searches directly in the PDCCH having the same DCI format as the first DCI. In some cases, the base station side may continuously transmit pieces of control information having the same DCI format to the terminal device. The scrambling indicating such association excludes PDCCH candidates with different DCI formats, so that the power consumption of the blind detection by the UE is significantly reduced compared to blind detection in the overall search space.

It should be noted that although the above example illustrates that the first terminal identifier for the wake-up indication DCI is predefined to be associated with the fourth condition that “the control channels in the set has a scheduling DCI format” and the second terminal identifier for the non-wake-up indication DCI is predefined to be associated with the first condition that “the control channel in the set has the same DCI format as the first DCI”, the embodiments of the present disclosure are not limited thereto, but may define other association based on application requirements, system requirements, scheduling requirements of the base station, and the like, which is not described in detail here.

The first configuration example of the electronic device on the base station side according to the embodiment of the present disclosure is described above with reference to FIG. 1 and FIG. 2. With the electronic device 100 according to the embodiment of the present disclosure, a first DCI may be scrambled with a predefined terminal identifier to indicate that a UE decodes a second DCI in a designated set of control channels. In this way, a range of blind detection or monitoring by the UE is reduced to a subset of control channels of the overall search space. In this way, the reduced set of control channels is implicitly indicated, which is not only conducive to reducing a power consumption of the UE for control channel monitoring, but also conducive to compatibility with existing signaling and reduce of a signaling overhead.

### 2.2 Second Configuration Example

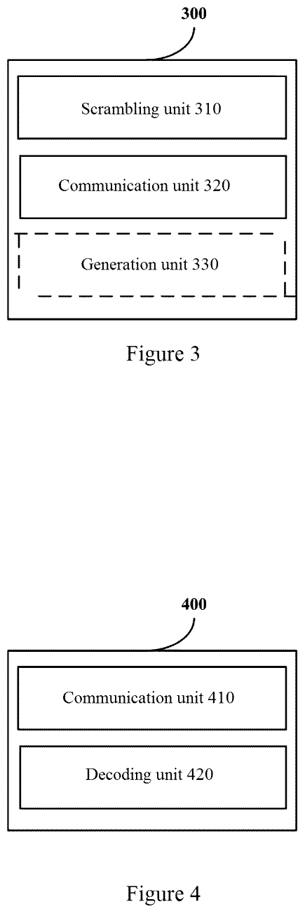

FIG. 3 is a block diagram showing a second configuration example of an electronic device on a base station side according to an embodiment of the present disclosure. The second configuration example shown in FIG. 3 is based on the first configuration example shown in FIG. 1, and therefore the following description is made based on the first configuration example shown in FIG. 1.

As shown in FIG. 3, the electronic device 300 may include a scrambling unit 310 and a communication unit 320, which are respectively similar to the scrambling unit 110 and the communication unit 120 in the electronic device 100 of FIG. 1. In addition, the electronic device 300 further includes a generation unit 330. The generation unit 330 is configured to generate various indication information when necessary, to provide the terminal device with (optional/additional) indication information on decoding the second DCI in a designated set of control channels. The indication information is, for example but not limited to, indication information indicating the number of second DCIs and/or indication information indicating a designated condition that the set of control channels for decoding the second DCI meet, which is described below. The UE that receives the indication information may decode the second DCI in the designated set of control channels according to the predefined terminal identifier that scrambles the first DCI and indication of the indication information.

As mentioned above, the second DCI may be a DCI to be transmitted after the first DCI. In a specific example, the second DCI may include one or more DCIs to be transmitted after the first DCI. Accordingly, the generation unit 330 of the electronic device 300 may be configured to generate indication information indicating the number of second DCIs (hereinafter also referred to as number indication information) in a case where the number of second DCIs is greater than 1, and may transmit the number indication information to the terminal device (UE) via the communication unit 320.

The number indication information may be carried and transmitted, for example, through Radio Resource Control (RRC) signaling or Media Access Control-Control Element (MAC CE) signaling.

In an example, the generation unit 330 may pre-generate number indication information designating the number N of second DCIs greater than 1 (where N is, for example, 2, 3, or 4, and may be determined based on the characteristic or regularity of data to be scheduled, for example), and transmit the number indication information to the UE in advance via RRC signaling (for example, the number N may be indicated by a predefined RRC parameter). Thereby, the UE receiving the indication information carried by the RRC signaling decodes or blindly detects N (second) DCIs subsequent to the first DCI in the designated set of control channels on each receipt of the first DCI scrambled with the predefined terminal identifier.

In another example, the generation unit 330 may generate in real time, for each first DCI, number indication information designating the number N of second DCIs greater than 1 (where N is, for example, 2, 3, or 4, and may be determined appropriately based on a situation of subsequent DCI, for example), and may transmit the number indication information to the UE in real time via MAC CE signaling (for example, the number N may be indicated by a predefined field in the MAC CE). Thereby, the UE receiving the indication information carried by the MAC CE signaling decodes or blindly detects N (second) DCIs subsequent to the first DCI in the designated set of control channels on receipt of the first DCI scrambled with the predefined terminal identifier.

It should be noted that, in a case where the number of second DCIs is 1, the generation unit 330 may not generate any number indication information, and the communication unit 320 may not transmit any number indication information to the UE. In a case where the UE fails to receive the number indication information, the UE decodes merely one second DCI, for example, by default in a designated set of control channels according to indication of the predefined terminal identifier scrambling the first DCI.

Furthermore, in the first configuration example described with reference to FIG. 1, an implementation is described in which the predefined terminal identifier may be directly defined to be associated with a designated set of control channels (more specifically, associated with a condition satisfied by the designated set of control channels). In the second configuration example shown in FIG. 2, there may be another implementation: for example, the predefined terminal identifier is only defined for the purpose of indicating a designated set of control channels, and is not defined to be associated with a specific set of control channels.

In this case, the generation unit 330 of the electronic device 300 may be configured to generate indication information (hereinafter also referred to as condition indication information) indicating a condition satisfied by a set of control channels for decoding the second DCI, such as indication information of one of the first condition to the fourth condition as described above, and may transmit the condition indication information to the terminal device (UE) via the communication unit 320. The UE that receives the condition indication information may directly decode the second DCI in a set of control channels that satisfies the condition designated by the indication information.

For example, the generation unit 330 may predefine a condition parameter for each of the first condition to the fourth condition, and designate one of the first to fourth conditions with a specific value of the condition parameter. As an example, values 0, 1, 2, and 3 of the condition parameter may be defined respectively corresponding to the first condition that the control channels in the designated set have the same DCI format as the first DCI, the second condition that the control channels in the set have the same aggregation level as a control channel carrying the first DCI, the third condition that the control channels in the set have the same search space identifier as a control channel carrying the first DCI, and the fourth condition that the control channels in the set have a scheduling DCI format.

In an example, the generation unit 330 may generate (condition) indication information designating one condition from multiple conditions (such as but not limited to the first to fourth conditions described above), and the communication unit 320 may transmit the condition indication information to the UE. The UE that receives the condition indication information may directly decode the second DCI in a set of control channels that satisfies the indicated condition.

For example, the generation unit 330 may generate condition indication information having a condition parameter (i.e., having a value of 0, 1, 2, or 3) based on characteristic or regularity of data/service to be scheduled, and the communication unit 320 may transmit the condition indication information to the UE, for example, via RRC signaling (for example, including an RRC condition parameter). In this case, a condition parameter in the condition indication information is applicable to all predefined terminal identifiers, such as but not limited to the first terminal identifier and the second terminal identifier described above.

As an example, the condition indication information may designate the first condition of having the same DCI format as the first DCI or the fourth condition of having a scheduling DCI format, that is, the condition parameter may have a value of 0 or 3, for example. The UE receiving the condition indication information decodes or blindly detects a second DCI subsequent to the first DCI in the set of control channels designated by the condition parameter (for example, a set of control channels having the same DCI format as the first DCI, or a set of control channels having a scheduling DCI format), on each receipt of the first DCI scrambled with the predefined terminal identifier. In this case, it is does not matter whether the first DCI is scrambled with the first terminal identifier or the second terminal identifier or whether the first DCI includes a wake-up indication.

In another example, the generation unit 330 may generate first (condition) indication information and second (condition) indication information, where the first (condition) indication information designates one of the conditions (for example but not limited to the first to fourth conditions mentioned above) which is satisfied by a set of control channels for decoding a second DCI subsequent to a first DCI including a wake-up indication, and the second (condition) indication information designates one of the conditions which is satisfied by a set of control channels for decoding a second DCI subsequent to a first DCI including no wake-up indication. The communication unit 320 may transmit the first (condition) indication information and the second (condition) indication information to the UE. The UE that receives the condition indication information may decode the second DCI in a set of control channels that satisfies the corresponding condition for different first DCIs based on different condition indication information.

For example, the generation unit 330 may generate first condition indication information and second condition indication information each having a condition parameter (i.e., having a value of 0, 1, 2, or 3). The condition parameter of the first indication information is applicable to decoding the second DCI subsequent to the first DCI including a wake-up indication (for example, DCI scrambled with the first terminal identifier), and the condition parameter of the second indication information is applicable to decoding the second DCI subsequent to the first DCI including no wake-up indication (for example, DCI scrambled with the second terminal identifier).

As an example, the first indication information may designate the fourth condition of having a scheduling DCI format, that is, the value of the first condition parameter may be 3; and the second indication information may designate the first condition of having the same DCI format as the first DCI, that is, the value of the second condition parameter may be 0.

The communication unit 320 may, for example, transmit the first condition indication information and the second condition indication information to the UE via RRC signaling (for example, including two RRC condition parameters). The UE that receives the first condition indication information and the second condition indication information may: decode or blind detect a second DCI subsequent to the first DCI in a set of control channels designated by the first condition indication information (for example, a set of control channels with a scheduling DCI format), on each receipt of the first DCI (e.g., WUS DCI) that is scrambled with the first terminal identifier and includes a wake-up indication; and decode or blind detect a second DCI subsequent to the first DCI in a set of control channels designated by the second condition indication information (for example, a set of control channels with the same DCI format as the first DCI), on each receipt of the first DCI (e.g., DCI other than the WUS DCI) that is scrambled with the second terminal identifier and includes no wake-up indication.

In the above two examples, the communication unit 320 transmits one or more condition indication information having the condition parameters in the form of RRC signaling, but the embodiment is not limited thereto. For example, additionally or alternatively, the communication unit 320 may, for example, transmit the one or more condition indication information to the UE via MAC CE signaling (for example, by indicating one or two condition parameters in a designated field of the MAC CE signaling) before transmitting the second DCI. Thereby, the UE that receives the condition indication information decodes or blindly detects the subsequent (second) DCI in the designated set of control channels, on receipt of the first DCI scrambled with the predefined terminal identifier.

The second configuration example of the electronic device on the base station side according to the embodiment of the present disclosure is described above with reference to FIG. 3. With the electronic device 300 according to the configuration example, (optional/additional) indication information on decoding the second DCI in a designated set of control channels can be generated and provided to the UE. Therefore, optional display indication can be provided on the basis of the implicit indication of the first configuration example, achieving more flexibility.

In the above description of the electronic device on the base station side according to the embodiment of the present disclosure, in addition to the electronic devices 100 and 300 on the base station side, the terminal device receiving the first DCI scrambled by the electronic device is described. In other words, according to the embodiment of the present disclosure, an electronic device on the terminal side is proposed in addition to the electronic device on the base station side. A description of the electronic device on the terminal side according to the embodiment of the present disclosure is given below based on the description of the electronic device on the base station side according to the embodiment of the present disclosure, and unnecessary details thereof are omitted.

### 3. Configuration Example of Electronic Device on Terminal Side

FIG. 4 is a block diagram showing a configuration example of an electronic device on a terminal side according to an embodiment.

As shown in FIG. 4, the electronic device 400 may include a communication unit 410 and a decoding unit 420. In addition, although not shown in the drawing, the electronic device 400 may further include a storage unit.

Here, units of the electronic device 400 may be included in processing circuitry. It should be noted that the electronic device 400 may include a single processing circuit or multiple processing circuits. Further, the processing circuitry may include various discrete functional units for performing various different functions and/or operations. It should be noted that these functional units may be physical entities or logical entities, and units with different names may be implemented by a same physical entity.

According to an embodiment of the present disclosure, the communication unit 410 of the electronic device 400 may be configured to receive a first downlink control information DCI scrambled with a predefined terminal identifier. The decoding unit 420 of the electronic device 400 may be configured to decode a second DCI in a designated set of control channels according to indication of the terminal identifier. Here, the decoding unit 420 may determine the terminal identifier for scrambling the first DCI by, for example, successfully decoding the first DCI using the predefined terminal identifier.

Alternatively, the electronic device 400 may further receive configuration information of multiple search spaces from the base station side (e.g., the electronic device 100 or 300 on the base station side described above with reference to FIG. 1 and FIG. 3) via the communication unit 410. Here, each search space may be pre-configured on the network side by configuring a DCI format to be monitored, an aggregation level of PDCCH (i.e., the number of continuous CCEs usable for the PDCCH, such as 1, 2, 3, 8 or 16), the number of PDCCH candidates at each aggregation level, and the like. As an example, the electronic device 400 may receive configuration information of pre-configured 10 search spaces, where the search spaces are represented by search space identifiers (SS id) 0 to 9, respectively. In this case, as the electronic device 400 receives the first DCI scrambled with the predefined terminal identifier through the communication unit 420, the decoding unit 100 may decode the second DCI in a designated set of control channels in all the search spaces (for example, all the 10 search spaces with SS ids 0 to 9) according to indication of the terminal identifier.

As mentioned above, one or more terminal identifiers may be predefined for designating a set of candidate control channels for blind decoding for the terminal device, and the electronic device 400 on the base station side and the UE on the terminal side may obtain relevant information (such as definition information or description information) of the terminal identifiers in advance through various appropriate manners.

For example, a first terminal identifier may be predefined for scrambling the first DCI including a wake-up indication (such as the first DCI as WUS DCI) to indicate that a subsequent second DCI is to be decoded in a designated set of control channels. The first terminal identifier uses a scrambling code different from an existing PS-RNTI for scrambling the WUS DCI, and may be named, for example, a new PS-RNTI.

In addition to indicating the scrambling code of the terminal identifier and the purpose, which is particularly concerned by the present disclosure, of the terminal identifier for indicating a designated set of control channels for decoding subsequent DCI (“second DCI”) for the terminal device, the related information (such as definition information or description information) of the predefined first terminal identifier further indicates a basic purpose that the terminal identifier is for indicating transmission of power-saving information, that is, scrambling the DCI (such as WUS DCI) including a wake-up indication. Thereby, on receipt of the WUS DCI scrambled with the first terminal identifier, the electronic device 400 may performs an activation operation under the control of the control unit (not shown), and blindly detects the second DCI using the designated set of control channels when DRX ON starts via the decoding unit 420.

In addition, a second terminal identifier may be predefined for scrambling the first DCI including no wake-up indication (such as DCI other than WUS DCI) to indicate that a subsequent second DCI is to be decoded in a designated set of control channels. The second terminal identifier may be named, for example, a monitoring reduction RNTI (MR-RNTI). The relevant information (such as definition information or description information) of a predefined second terminal identifier may simply indicate the scrambling code of the terminal identifier and the purpose of the terminal identifier for indicating a designated set of control channels for decoding subsequent DCI (“second DCI”) for the terminal device.

In an example, the first DCI received by the communication unit 410 includes a wake-up indication (for example, the first DCI is the WUS DCI), and the terminal identifier for scrambling the first DCI is the above-mentioned first terminal identifier. In another example, the first DCI received by the communication unit 410 includes no wake-up indication (for example, the first DCI is another DCI other than the WUS DCI), and the terminal identifier for scrambling the first DCI is the above-mentioned second terminal identifier. Examples of the above two situations are as shown in (A) and (B) in FIG. 2 described above, and are not repeated here.

In an implementation, the predefined terminal identifier (such as but not limited to the above-mentioned first terminal identifier or second terminal identifier) may be directly defined to be associated with a designated set of control channels, and more specifically may be associated with a condition satisfied by a designated set of control channels. In this case, in addition to indicating the scrambling code of the terminal identifier and the purpose of the terminal identifier for indicating a designated set of control channels for decoding for the terminal device, the relevant information of the predefined terminal identifier obtained by the device on the base station side or the terminal side through various appropriate manners may further indicate a condition satisfied by a set of control channels associated with the terminal identifier. Since the association between the terminal identifier and the condition satisfied by the set of control channels is directly designated in the relevant information obtained in advance by the base station side or the terminal side, it is beneficial to further reduce of the signaling overhead.

As an example, a condition that the designated set of control channels satisfies or meets may include but is not limited to: a first condition that the control channels in the set have the same DCI format as the first DCI; a second condition that the control channels in the set have the same aggregation level as a control channel carrying the first DCI; a third condition that the control channels in the set have the same search space identifier as a control channel carrying the first DCI; or a fourth condition that the control channels in the set have a scheduling DCI format. Although further description is given herein in conjunction with the first to fourth conditions as examples, the condition satisfied by the designated set of control channels in the present disclosure is not limited thereto, but as long as a subset of all candidate control channels (all search spaces) can be designated to narrow a range of blind detection by the UE, which is not described in detail here.

For example, the first terminal identifier for scrambling DCI including a wake-up indication may be predefined to be associated with the fourth condition that “the control channels in the set have a scheduling DCI format”.

Generally, after the base station side transmits the first DCI as the WUS DCI to the electronic device 400 on the terminal side, the electronic device 400 is woken up, and the base station side then transmits the second DCI for scheduling to the electronic device 400. Correspondingly, the base station may scramble the WUS DCI with the first terminal identifier, which is associated with the fourth condition and for indicating transmission of the power-saving information, and thereby activate the electronic device 400 and indicate that the electronic device 400 searches for the subsequent second DCI through the decoding unit 420 directly in the PDCCH having the scheduling DCI format when DRX ON starts. As mentioned above, through the scrambling indicating the association, a PDCCH candidate in a non-scheduling DCI format is excluded from the range of the blind detection by the UE. In this way, the power consumption of the blind detection by the decoding unit 420 is significantly reduced compared to blind detection in the overall search space, and the efficiency of blind detection is improved.

Similarly, the second terminal identifier for scrambling DCI including no wake-up indication may be predefined to be associated with the fourth condition that “the control channels in the set have a scheduling DCI format”.

Hence, in a case where the first DCI is DCI other than WUS DCI (such as scheduling DCI), as the second DCI to be transmitted is scheduling DCI, the base station side may scramble the first DCI with the second terminal identifier associated with the fourth condition, indicating that the electronic device 400 on the terminal searches directly in the PDCCH having the scheduling DCI format. As mentioned before, the scrambling indicating the association may be particularly beneficial in some applications such as XR-related applications that transmit a large amount of scheduling DCI, in which the power consumption of the blind detection by the decoding unit 420 is significantly reduced and the efficiency of blind detection is improved.

In addition, alternatively, for example, the second terminal identifier for scrambling DCI including no wake-up indication may be predefined to be associated with the first condition that “the control channels in the set have the same DCI format as the first DCI”.

Hence, in a case where the first DCI is DCI other than WUS DCI (such as scheduling DCI), as the second DCI to be transmitted has the same DCI format as the first DCI, the base station side may scramble the first DCI with the second terminal identifier associated with the first condition, indicating that the electronic device 400 on the terminal side searches directly in the PDCCH having the same DCI format as the first DCI. In some cases, the base station side may continuously transmit pieces of control information having the same DCI format to the electronic device 400. The scrambling indicating such association excludes PDCCH candidates with different DCI formats, so that the power consumption of the blind detection by the decoding unit 420 is significantly reduced compared to blind detection in the overall search space.

It should be noted that although the above example illustrates that the first terminal identifier for the wake-up indication DCI is predefined to be associated with the fourth condition that “the control channels in the set has a scheduling DCI format” and the second terminal identifier for the non-wake-up indication DCI is predefined to be associated with the first condition that “the control channel in the set has the same DCI format as the first DCI”, the embodiments of the present disclosure are not limited thereto, but may define other association based on application requirements, system requirements, scheduling requirements of the base station, and the like, which is not described in detail here.

Alternatively, the communication unit 410 of the electronic device 400 may be further configured to receive, from the base station side, (optional/additional) indication information on decoding the second DCI in a designated set of control channels. The indication information is, for example but not limited to, indication information indicating the number of second DCIs and/or indication information indicating a designated condition satisfied by the designated set of control channels for decoding the second DCI. The decoding unit 420 of the electronic device 400 may be further configured to decode the second DCI in the designated set of control channels according to the predefined terminal identifier that scrambles the first DCI and indication of the indication information received.

As mentioned above, the second DCI may be a DCI to be transmitted after the first DCI. In a specific example, the second DCI may include one or more DCIs to be transmitted after the first DCI. Correspondingly, the communication unit 410 of the electronic device 400 may be configured to receive indication information (number indication information) indicating the number of second DCIs, where the indication information indicates a number greater than 1. The decoding unit 420 may decode the indicated number of second DCIs in the designated set of control channels according to the number indication information. In a case of failing to receive the indication information, the decoding unit 420 may decode merely one second DCI, for example, by default in a designated set of control channels according to indication of the predefined terminal identifier scrambling the first DCI.

For example, the communication unit 410 may receive the number indication information via radio resource control RRC signaling or media access control element MAC CE signaling.

In an example, the communication unit 410 may receive number indication information designating the number N of second DCIs greater than 1 transmitted in advance by the base station side via RRC signaling (where N is, for example, 2, 3, or 4, and may be designated by the base station side based on the characteristic or regularity of data to be scheduled, and the number N may be indicated by the predefined RRC parameter). The electronic device 400 that receives the indication information carried by the RRC signaling may decode or blind detect N (second) DCIs subsequent to the first DCI in the designated set of control channels via the decoding unit 420, on each receipt of the first DCI scrambled with the predefined terminal identifier.

In another example, the communication unit 410 may receive number indication information designating the number N of second DCIs greater than 1 transmitted in real time for each first DCI by the base station side via MAC CE signaling (where N is, for example, 2, 3, or 4, and may be designated appropriately by the base station side based on the subsequent DCI, and the number N may be indicated by a predefined field in the MAC CE). The electronic device 400 that receives the indication information carried by the MAC CE signaling may decode or blind detect N (second) DCIs subsequent to the first DCI in the designated set of control channels via the decoding unit 420, on receipt of the first DCI scrambled with the predefined terminal identifier.

Furthermore, an implementation is described in which the predefined terminal identifier may be directly defined to be associated with a designated set of control channels (more specifically, associated with a condition satisfied by the designated set of control channels). Alternatively, there may be another implementation: for example, the predefined terminal identifier is only defined for the purpose of indicating a designated set of control channels, and is not defined to be associated with a specific set of control channels.

In this case, the communication unit 410 of the electronic device 400 on the terminal side may be configured to receive indication information indicating a condition satisfied by a set of control channels for decoding the second DCI, such as indication information of one of the first condition to the fourth condition as described above (hereinafter also referred to as condition indication information), and the decoding unit 420 may be configured to directly decode the second DCI in a set of control channels that satisfies the condition designated by the indication information.

For example, a condition parameter for each of the first condition to the fourth condition may be predefined as described above, where one of the first to fourth conditions is designated with a specific value of the condition parameter. As an example, values 0, 1, 2, and 3 of the condition parameter may be defined respectively corresponding to the first condition that the control channels in the set have the same DCI format as the first DCI, the second condition that the control channels in the set have the same aggregation level as a control channel carrying the first DCI, the third condition that the control channels in the set have the same search space identifier as a control channel carrying the first DCI, and the fourth condition that the control channels in the set have a scheduling DCI format.

In an example, the communication unit 410 may receive, from the base station side, (condition) indication information designating one condition from multiple conditions (such as but not limited to the first to fourth conditions described above), and the decoding unit 420 may decode the second DCI in a set of control channels that satisfies the condition.

For example, the condition indication information received by the communication unit 410 may have a condition parameter (i.e., having a value of 0, 1, 2, or 3) which is generated on the base station side based on characteristic or regularity of data/service to be scheduled, and the condition indication information may be received via RRC signaling (for example, including an RRC condition parameter). In this case, the decoding unit 420 defaults that one condition parameter in the condition indication information is applicable to the implicit indication of the blind detection range of all first DCIs for the second DCI (for example, the implicit indication of DCIs scrambled with all predefined terminal identifiers, such as but not limited to the first terminal identifier and the second terminal identifier described above.

As an example, the condition indication information may designate the first condition of having the same DCI format as the first DCI or the fourth condition of having a scheduling DCI format, that is, the condition parameter may have a value of 0 or 3, for example. The electronic device 400 receiving the condition indication information may decode or blindly detect, via the decoding unit 420, a second DCI subsequent to the first DCI in the set of control channels designated by the condition parameter (for example, a set of control channels having the same DCI format as the first DCI, or a set of control channels having a scheduling DCI format), on each receipt of the first DCI scrambled with the predefined terminal identifier. In this case, it is does not matter whether the first DCI is scrambled with the first terminal identifier or the second terminal identifier or whether the first DCI includes a wake-up indication.

In another example, the communication unit 410 may receive, from the base station side, first (condition) indication information and second (condition) indication information, where the first (condition) indication information designates one of the conditions (for example but not limited to the first to fourth conditions mentioned above) which is satisfied by a set of control channels for decoding a second DCI subsequent to a first DCI including a wake-up indication, and the second (condition) indication information designates one of the conditions which is satisfied by a set of control channels for decoding a second DCI subsequent to a first DCI including no wake-up indication. The decoding unit 420 may decode the second DCI in a set of control channels that satisfies the corresponding condition for different first DCIs based on different condition indication information.

For example, first (condition) indication information and second (condition) indication information received by the communication unit 410 may each have a condition parameter (i.e., have a value of 0, 1, 2, or 3). The condition parameter of the first indication information is applicable to decoding the second DCI subsequent to the first DCI including a wake-up indication (for example, DCI scrambled with the first terminal identifier), and the condition parameter of the second indication information is applicable to decoding the second DCI subsequent to the first DCI including no wake-up indication (for example, DCI scrambled with the second terminal identifier).

As an example, the first indication information may designate the fourth condition of having a scheduling DCI format, that is, the value of the first condition parameter may be 3; and the second indication information may designate the first condition of having the same DCI format as the first DCI, that is, the value of the second condition parameter may be 0.

The communication unit 410 may, for example, receive the first condition indication information and the second condition indication information (for example, including two RRC condition parameters) via RRC signaling. The electronic device 400 that receives the first and the second condition indication information may decode or blind detect the second DCI subsequent to the first DCI in a set of control channels designated by the first condition indication information (such as a set of control channels having a scheduling DCI format) via the decoding unit 420, on each receipt of the first DCI (e.g., WUS DCI) scrambled with the first terminal identifier and including a wake-up indication via the communication unit 410. In addition, the electronic device 400 may decode or blind detect the second DCI subsequent to the first DCI in a set of control channels designated by the second condition indication information (such as a set of control channels having the same DCI format as the first DCI) via the decoding unit 420, on each receipt of the first DCI (e.g., DCI other than WUS DCI) scrambled with the second terminal identifier and including no wake-up indication via the communication unit 410.

In the above examples, the communication unit 410 receives one or more condition indication information having the condition parameters carried by RRC signaling, but the embodiment is not limited thereto. For example, additionally or alternatively, the communication unit 410 may, for example, receive the one or more condition indication information via MAC CE signaling (for example, by indicating one or two condition parameters in a designated field of the MAC CE signaling) before receiving or decoding the second DCI. The electronic device 400 that receives the condition indication information carried by the MAC CE signaling may decode or blind detect the subsequent (second) DCI in the designated set of control channels via the decoding unit 420, on receipt of the first DCI scrambled with the predefined terminal identifier via the communication unit 410.

### 4. Signaling Process Example

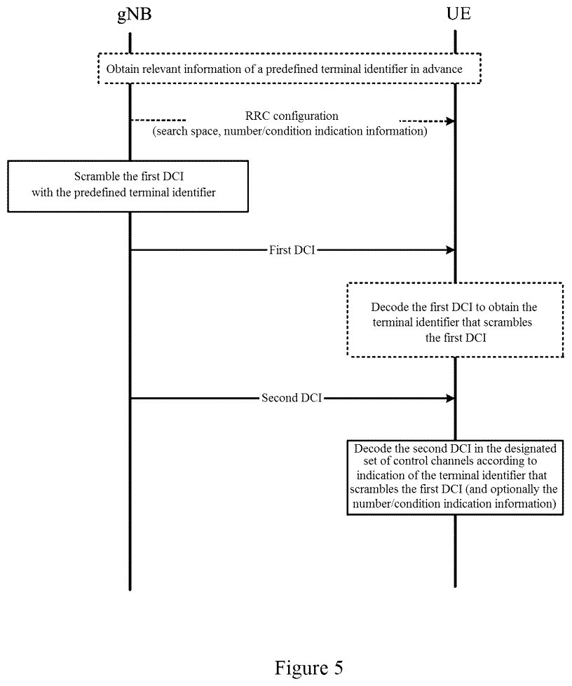

Next, an example signaling interaction for transmitting and decoding DCI between an electronic device on a base station side and an electronic device on a terminal side according to an embodiment of the present disclosure is described with reference to an example shown in FIG. 5. The signaling interaction may be implemented, for example, through interactions between the electronic device 100 or 300 on the base station side and the electronic device 400 on the terminal side.

More specifically, in the example of FIG. 5, a base station gNB may have, for example, the functional configuration of the electronic device 100 or 300 on a base station side, and a terminal device UE may have, for example, the functional configuration of the electronic device 400 on a terminal side.

As shown in FIG. 5, in this example, the gNB and the UE first (respectively or jointly) obtain related information (definition, description, or the like) of one or more predefined terminal identifiers (such as but not limited to the first terminal identifier and the second terminal identifier described above) in advance through an appropriate manner.

Then, the gNB may perform RRC configuration on the UE, which may include configuring multiple search spaces. In addition, in a case where the number of second DCIs is greater than 1 and/or in a case where the predefined terminal identifier is not defined to be directly associated with a designated set of control channels, alternatively, the RRC configuration may further include the indication information of the number and/or the indication information of one or more conditions as described above, and the like.

Then, the gNB may scramble the first DCI with the predefined terminal identifier and transmit the first DCI to the UE.

Correspondingly, the UE may obtain the terminal identifier by successfully decoding the first DCI using the predefined terminal identifier, and may decode the second DCI in a designated set of control channels according to indication of the terminal identifier scrambling the first DCI (and indication information of an optional number/condition).

In the example of FIG. 5, no distinction is made as to whether the first DCI is a DCI including a wake-up indication such as a WUS DCI, as this is irrelevant to the focus of this example on scrambling the first DCI to implicitly indicate a set of control channels for decoding the second DCI. It may be understood that in a case where the first DCI is WUS DCI, after the UE decodes the first DCI and obtains the first terminal identifier that scrambles the first DCI, the UE is activated by the WUS DCI and performs a process of subsequent decoding of the second DCI as the DRX ON starts, which is not described in further detail here.

Furthermore, the example of FIG. 5 shows that the gNB transmits the number indication information, the condition indication information, and the like, to the UE via the RRC signaling. It may be understood that the embodiment of the present disclosure is not limited thereto. The gNB may transmit the number indication information and the condition indication information to the UE via MAC CE signaling, for example, before transmitting the first DCI and/or the second DCI, which is not described in further detail here.

### 5. Method Embodiment

Corresponding to the device embodiments, the present disclosure provides the following method embodiments.

### Method Embodiments on Base Station Side

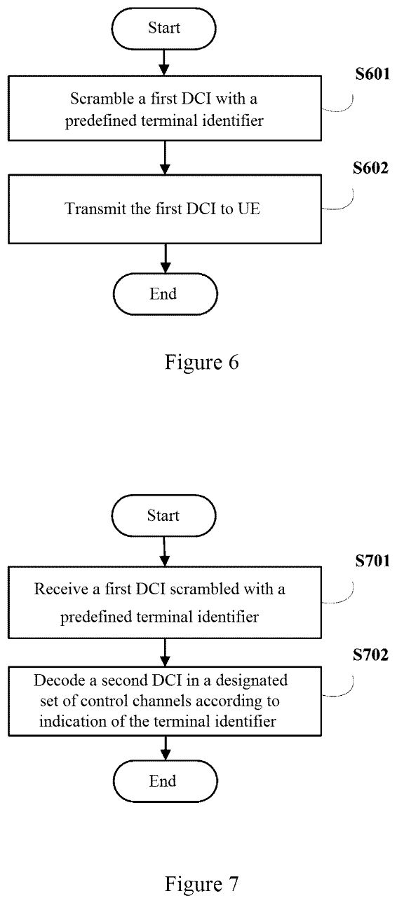

FIG. 6 is a flowchart illustrating a process example of a method for wireless communication on a base station side according to an embodiment of the present disclosure.

As shown in FIG. 6, in step S601, a first downlink control information, DCI, is scrambled with a predefined terminal identifier, to indicate that a terminal device (UE) decodes a second DCI in a designated set of control channels.

As an example, the second DCI may include one or more DCIs to be transmitted after the first DCI.

Then, in step S602, the scrambled first DCI is transmitted to the terminal device (UE).

In addition, although not shown in the figure, the example process of FIG. 6 may alternatively include, for example, a step of transmitting the second DCI to the terminal device.

In an example, the first DCI may include a wake-up indication, and the terminal identifier may be a first terminal identifier for scrambling the first DCI including a wake-up indication to indicate that a subsequent second DCI is to be decoded in a designated set of control channels. In another example, the first DCI may include no wake-up indication, and the terminal identifier may be a second terminal identifier for scrambling the first DCI including no wake-up indication to indicate that a subsequent second DCI is to be decoded in a designated set of control channels.

As an example, the designated set of control channels may satisfy one condition of the following plurality of conditions: a first condition that the control channels in the set have the same DCI format as the first DCI; a second condition that the control channels in the set have the same aggregation level as a control channel carrying the first DCI; a third condition that the control channels in the set have the same search space identifier as a control channel carrying the first DCI; or a fourth condition that the control channels in the set have a scheduling DCI format.

In an implementation, the first DCI may include a wake-up indication, and the terminal identifier may be a first terminal identifier for scrambling the first DCI including a wake-up indication to indicate that a subsequent second DCI is to be decoded in a set of control channels satisfying the fourth condition. Alternatively, the first DCI may include no wake-up indication, and the terminal identifier may be a first terminal identifier for scrambling the first DCI including no wake-up indication to indicate that a subsequent second DCI is to be decoded in a set of control channels satisfying the fourth condition.

In addition, the example process of FIG. 6 may further include a step of transmitting optional indication information.

For example, although not shown in the figure, the example process in FIG. 6 may additionally include the following step before the additional step of transmitting the second DCI: transmitting, to the terminal device, indication information indicating the number of second DCIs, in a case where the number of second DCIs is more than 1.

In addition, although not shown in the figure, the example process in FIG. 6 may additionally include the following step before the additional step of transmitting the second DCI: transmitting, to the terminal device, indication information designating one of the conditions.

Alternatively, although not shown in the figure, the example process in FIG. 6 may additionally include, before the additional step of transmitting the second DCI, the following step: transmitting first indication information and second indication information to the terminal device, where the first indication information designates one of the conditions which is satisfied by a set of control channels for decoding a second DCI subsequent to a first DCI including a wake-up indication, and the second indication information designates one of the conditions which is satisfied by a set of control channels for decoding a second DCI subsequent to a first DCI including no wake-up indication. In a preferred embodiment, the first indication information may designate the fourth condition, and the second indication information may designate the first condition.

As an example, the indication information may be transmitted via radio resource control RRC signaling or media access control element MAC CE signaling.

According to an embodiment of the present disclosure, a subject that performs the method may be the electronic device 100 or 300 on the base station side according to the embodiments of the present disclosure. Therefore, the previous embodiments of the electronic device on the base station side are applicable here and are not repeated here.

### Method Embodiments on User Side

FIG. 7 is a flowchart illustrating a process example of a method for wireless communication on a user side according to an embodiment.

As shown in FIG. 7, in step S701, a first downlink control information DCI scrambled with a predefined terminal identifier is received.

Then, in step S702, a second DCI is decoded in a designated set of control channels according to indication of the terminal identifier scrambling the first DCI. Here, the terminal identifier for scrambling the first DCI may be determined by, for example, successfully decoding the first DCI using the predefined terminal identifier.

As an example, the second DCI may include one or more DCIs to be transmitted after the first DCI.

In an example, the first DCI may include a wake-up indication, and the terminal identifier may be a first terminal identifier for scrambling the first DCI including a wake-up indication to indicate that a subsequent second DCI is to be decoded in a designated set of control channels. In another example, the first DCI may include no wake-up indication, and the terminal identifier may be a second terminal identifier for scrambling the first DCI including no wake-up indication to indicate that a subsequent second DCI is to be decoded in a designated set of control channels.

As an example, the designated set of control channels may satisfy one condition of the following plurality of conditions: a first condition that the control channels in the set have the same DCI format as the first DCI; a second condition that the control channels in the set have the same aggregation level as a control channel carrying the first DCI; a third condition that the control channels in the set have the same search space identifier as a control channel carrying the first DCI; or a fourth condition that the control channels in the set have a scheduling DCI format.

In an implementation, the first DCI may include a wake-up indication, and the terminal identifier may be a first terminal identifier for scrambling the first DCI including a wake-up indication to indicate that a subsequent second DCI is to be decoded in a set of control channels satisfying the fourth condition. Alternatively, the first DCI may include no wake-up indication, and the terminal identifier may be a first terminal identifier for scrambling the first DCI including no wake-up indication to indicate that a subsequent second DCI is to be decoded in a set of control channels satisfying the fourth condition.

In addition, the example process of FIG. 7 may further include a step of receiving optional indication information.

For example, although not shown in the figure, the example process in FIG. 7 may additionally include, before step S702, the following step: receive indication information indicating the number of second DCIs, where the indication information indicates a number greater than one.

In addition, although not shown in the figure, the example process in FIG. 7 may additionally include, before step S702, the following step: receiving indication information designating one of the conditions.

Alternatively, although not shown in the figure, the example process in FIG. 7 may additionally include, before step S702, the following step: receiving first indication information and second indication information, where the first indication information designates one of the conditions which is satisfied by a set of control channels for decoding a second DCI subsequent to a first DCI including a wake-up indication, and the second indication information designates one of the conditions which is satisfied by a set of control channels for decoding a second DCI subsequent to a first DCI including no wake-up indication. In a preferred embodiment, the first indication information may designate the fourth condition, and the second indication information may designate the first condition.

As an example, the indication information may be received via radio resource control RRC signaling or media access control element MAC CE signaling.

On receipt of the one or more indication information, in step S702, the second DCI may be decoded in a designated set of control channels according to the indication of the terminal identifier scrambling the first DCI and the indication information.

According to an embodiment of the present disclosure, a subject that performs the method may be the electronic device 400 on the terminal side according to the embodiments of the present disclosure. Therefore, the previous embodiments of the electronic device on the terminal side are applicable here and are not repeated here.

### 6. Application Example

The technology of the present disclosure is applicable to various products.

For example, the electronic device 100 and the electronic device 300 described with reference to FIG. 1 and FIG. 3 may be implemented on a base station side. In a case where the electronic device is implemented on the base station side, the electronic device may be implemented as a base station device in any type, such as a macro eNB and a small eNB, or may be implemented as a gNB (a base station in a 5G system) in any type. The small eNB may be an eNB covering a cell smaller than a macro cell, such as a pico eNB, a micro eNB, or a home (femto) eNB. Alternatively, the base station may be implemented as any other type of base station, such as a NodeB or a base transceiver station (BTS). The base station may include a body (which is also referred to as a base station device) configured to control wireless communications and one or more remote radio heads (RRHs) arranged at a different place from the body.

The electronic device on the base station side may be implemented as a TRP in any type. The TRP may have functions of transmitting and receiving. For example, the TRP may receive information from a user equipment and a base station device, and may transmit information to a user equipment and a base station device. In a typical example, the TRP may provide services to the user equipment and is controlled by the base station device. Furthermore, the TRP may have a similar structure to that of the base station device, or may have merely a structure related to information transmitting and receiving in the base station device.

In addition, the electronic device 400 described with reference to FIG. 4 may be implemented on the terminal side. In a case where the electronic device is implemented on the terminal side, as a terminal device for example, the electronic device may be various user equipment. The user equipment may be implemented as a mobile terminal (such as a smart phone, a tablet personal computer (PC), a notebook PC, a portable game terminal, a portable/dongle-type mobile router, and a digital camera) or a vehicle-mounted terminal (such as an automobile navigation device). The user equipment may be implemented as a terminal that performs machine-to-machine (M2M) communications (which is also referred to as a machine type communication (MTC) terminal). Furthermore, the user equipment may be a wireless communication module (such as an integrated circuit module including a single wafer) installed on each user equipment described above.

### Application Examples of Base Station

### First Application Example

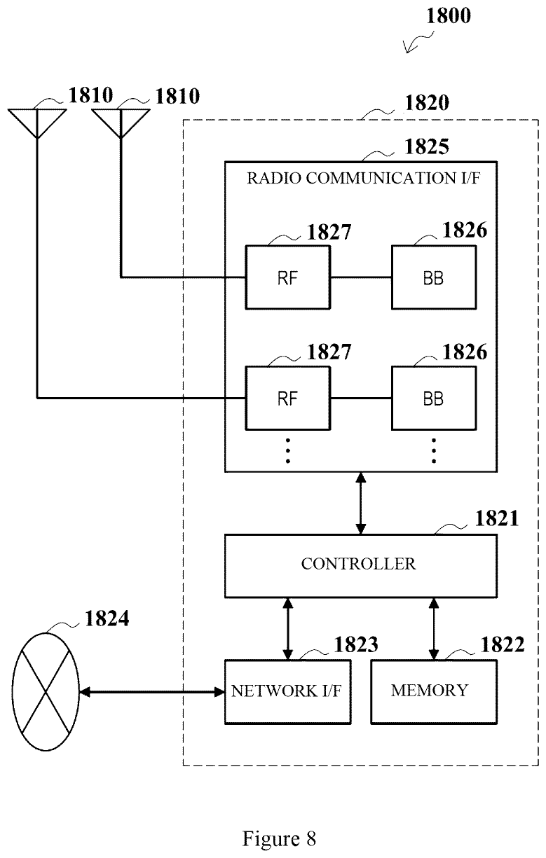

FIG. 8 is a block diagram showing a first example of a schematic configuration of an eNB to which the technology of the present disclosure may be applied. An eNB 1800 includes one or more antennas 1810 and a base station device 1820. The base station device 1820 and each of the antennas 1810 may be connected to each other via a RF cable.

Each of the antennas 1810 includes a single or multiple antenna elements (such as multiple antenna elements included in a multi-input multi-output (MIMO) antenna), and is used for the base station device 1820 to transmit and receive wireless signals. As shown in FIG. 8, the eNB 1800 may include multiple antennas 1810. For example, the multiple antennas 1810 may be compatible with multiple frequency bands used by the eNB 1800. Although FIG. 8 shows an example in which the eNB 1800 includes multiple antennas 1810, the eNB 1800 may include a single antenna 1810.

The base station device 1820 includes a controller 1821, a memory 1822, a network interface (I/F) 1823, and a radio communication interface 1825.

The controller 1821 may be, for example, a CPU or DSP, and operates various functions of a higher layer of the base station device 1820. For example, the controller 1821 generates a data packet based on data in a signal processed by the radio communication interface 1825, and transfers the generated packet via the network interface 1823. The controller 1821 may bundle data from multiple baseband processors to generate a bundled packet, and transfer the generated bundled packet. The controller 1821 may have logical functions of performing control such as radio resource control, radio bearer control, mobility management, admission control, and scheduling. The control may be performed in conjunction with a nearby eNB or a core network node. The memory 1822 includes an RAM and an ROM, and stores a program executed by the controller 1821 and various types of control data (such as a terminal list, transmission power data, and scheduling data).

The network interface 1823 is a communication interface for connecting the base station device 1820 to a core network 1824. The controller 1821 may communicate with the core network node or another eNB via the network interface 1823. In this case, the eNB 1800 and the core network node or another eNB may be connected to each other through a logical interface (such as an S1 interface and an X2 interface). The network interface 1823 may be a wired communication interface or a radio communication interface for a wireless backhaul line. In a case that the network interface 1823 is a radio communication interface, the network interface 1823 may use a higher frequency band for wireless communications than a frequency band used by the radio communication interface 1825.

The radio communication interface 1825 supports any cellular communication scheme (such as Long-Term Evolution (LTE) and LTE-Advanced), and provides wireless connection to a terminal in a cell of the eNB 1800 via the antenna 1810. The radio communication interface 1825 may typically include, for example, a baseband (BB) processor 1826 and an RF circuit 1827. The BB processor 1826 may perform, for example, coding/decoding, modulation/demodulation and multiplexing/de-multiplexing, and perform various types of signal processes of layers (for example, L1, media access control (MAC), radio link control (RLC) and packet data convergence protocol (PDCP)). Instead of the controller 1821, the BB processor 1826 may have a part or all of the above-mentioned logical functions. The BB processor 1826 may be a memory storing a communication control program, or a module including a processor and a related circuit configured to execute the program. Updating the program may change the functions of the BB processor 1826. The module may be a card or blade inserted into a slot of the base station device 1820. Alternatively, the module may be a chip mounted on the card or blade. In addition, the RF circuit 1827 may include, for example, a mixer, a filter and an amplifier, and transmit and receive a wireless signal via the antenna 1810.

As shown in FIG. 8, the radio communication interface 1825 may include multiple BB processors 1826. For example, the multiple BB processors 1826 may be compatible with multiple frequency bands used by the eNB 1800. As shown in FIG. 8, the radio communication interface 1825 may include multiple RF circuits 1827. For example, the multiple RF circuits 1827 may be compatible with multiple antenna elements. Although FIG. 8 shows an example in which the radio communication interface 1825 includes multiple BB processors 1826 and multiple RF circuits 1827, the radio communication interface 1825 may include a single BB processor 1826 or a single RF circuit 1827.

In the eNB 1800 shown in FIG. 8, the communication unit in the electronic device 100 or the electronic device 300 described with reference to FIG. 1 or FIG. 3 may be implemented through radio wireless communication interface 1825 and the optional antenna 1810. At least part of the function of the scrambling unit in the electronic device 100 or 300 and the function of the generation unit in the electronic device 300 may be implemented by the controller 1821. For example, the controller 1821 may implement all or part of the function of the scrambling unit or the generation unit by executing instructions stored in the memory 1822. Furthermore, the storage unit not shown in the electronic device 100 or 300 may be implemented through the memory 1822.

### Second Application Example

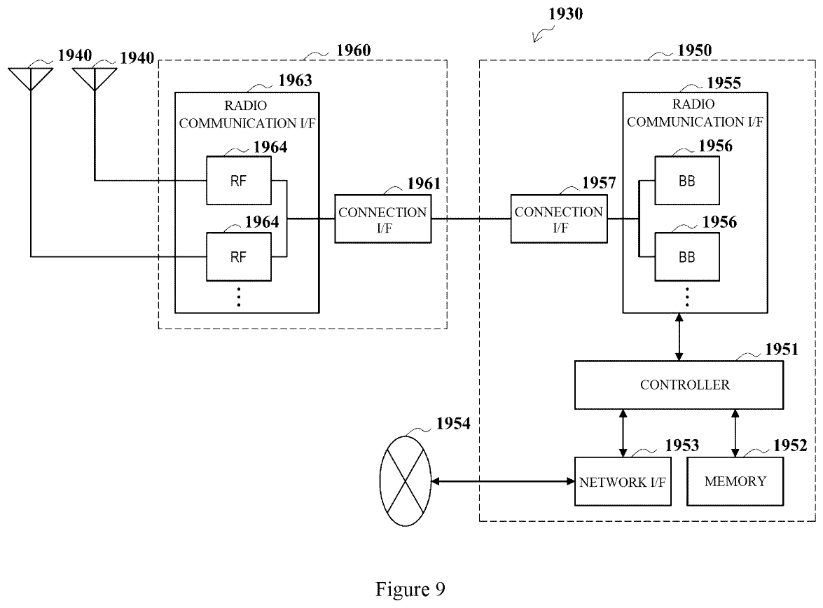

FIG. 9 is a block diagram showing a second example of a schematic configuration of an eNB to which the technology of the present disclosure may be applied. An eNB 1930 includes a single or multiple antennas 1940, a base station device 1950 and an RRH 1960. The RRH 1960 and each of the antennas 1940 may be connected to each other via an RF cable. The base station device 1950 and the RRH 1960 may be connected to each other via a high-speed line such as an optical fiber cable.

Each of the antennas 1940 includes a single or multiple antenna elements (such as multiple antenna elements included in a MIMO antenna), and is used for the RRH 1960 to transmit and receive a wireless signal. As shown in FIG. 9, the eNB 1930 may include multiple antennas 1940. For example, the multiple antennas 1940 may be compatible with multiple frequency bands used by the eNB 1930. Although FIG. 9 shows an example in which the eNB 1930 includes multiple antennas 1940, the eNB 1930 may include a single antenna 1940.

The base station device 1950 includes a controller 1951, a memory 1952, a network interface 1953, a radio communication interface 1955, and a connection interface 1957. The controller 1951, the memory 1952, and the network interface 1953 are the same as the controller 1821, the memory 1822, and the network interface 1823 described with reference to FIG. 8.

The radio communication interface 1955 supports any cellular communication scheme (such as LTE and LTE-advanced), and provides wireless communications to a terminal located in a sector corresponding to the RRH 1960 via the RRH 1960 and the antenna 1940. The radio communication interface 1955 may typically include, for example, a BB processor 1956. The BB processor 1956 is the same as the BB processor 1826 described with reference to FIG. 8, except that the BB processor 1956 is connected to an RF circuit 1964 of the RRH 1960 via the connection interface 1957. As shown in FIG. 9, the radio communication interface 1955 may include multiple BB processors 1956. For example, the multiple BB processors 1956 may be compatible with multiple frequency bands used by the eNB 1930. Although FIG. 9 shows an example in which the radio communication interface 1955 includes multiple BB processors 1956, the radio communication interface 1955 may include a single BB processor 1956.

The connection interface 1957 is an interface for connecting the base station device 1950 (the radio communication interface 1955) to the RRH 1960. The connection interface 1957 may be a communication module for communication in the above-described high-speed line that connects the base station device 1950 (the radio communication interface 1955) to the RRH 1960.

The RRH 1960 includes a connection interface 1961 and a radio communication interface 1963.

The connection interface 1961 is an interface for connecting the RRH 1960 (the radio communication interface 1963) to the base station device 1950. The connection interface 1961 may be a communication module for communication in the above-mentioned high-speed line.

The radio communication interface 1963 transmits and receives wireless signals via the antenna 1940. The radio communication interface 1963 may typically include, for example, the RF circuit 1964. The RF circuit 1964 may include, for example, a mixer, a filter and an amplifier, and transmit and receive wireless signals via the antenna 1940. As shown in FIG. 9, the radio communication interface 1963 may include multiple RF circuits 1964. For example, the multiple RF circuits 1964 may support multiple antenna elements. Although FIG. 9 shows an example in which the radio communication interface 1963 includes multiple RF circuits 1964, the radio communication interface 1963 may include a single RF circuit 1964.

In the eNB 1930 shown in FIG. 9, the communication unit in the electronic device 100 or the electronic device 300 described with reference to FIG. 1 or FIG. 3 may be implemented through the radio wireless communication interface 1963 and the optional antenna 1940, for example. At least part of the function of the scrambling unit in the electronic device 100 or 300 and the function of the generation unit in the electronic device 300 may be implemented by the controller 1951. For example, the controller 1951 may implement all or part of the function of the scrambling unit or the generation unit by executing instructions stored in the memory 1952. Furthermore, the storage unit not shown in the electronic device 100 or 300 may be implemented through the memory 1952.

### Application Example of User Equipment

### First Application Example

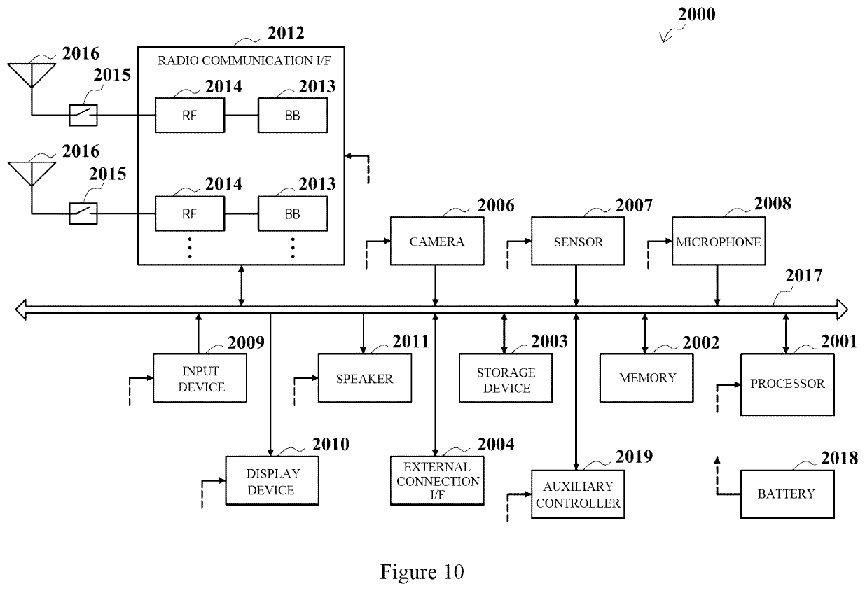

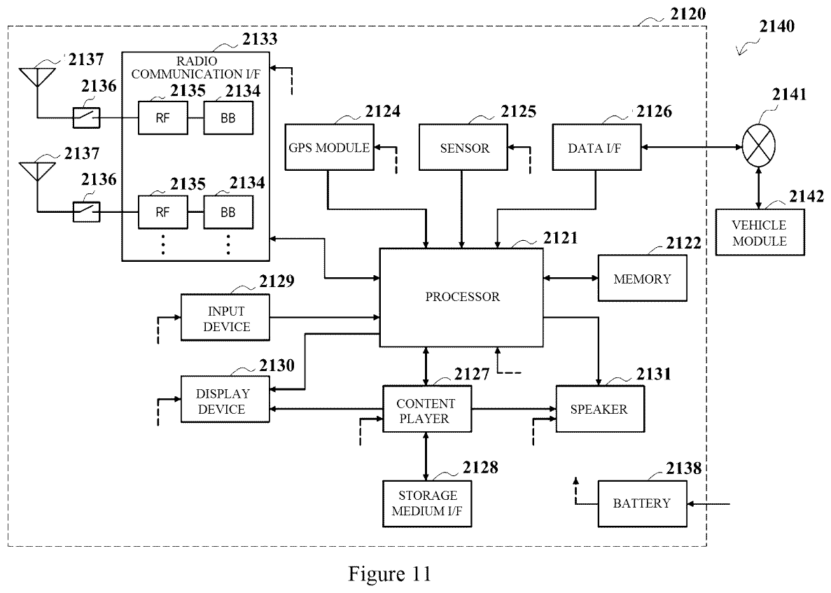

FIG. 10 is a block diagram showing an example of a schematic configuration of a smart phone 2000 to which the technology of the present disclosure is applicable. The smart phone 2000 includes a processor 2001, a memory 2002, a storage device 2003, an external connection interface 2004, a camera 2006, a sensor 2007, a microphone 2008, an input device 2009, a display device 2010, a speaker 2011, a radio communication interface 2012, one or more antenna switches 2015, one or more antennas 2016, a bus 2017, a battery 2018, and an auxiliary controller 2019.

The processor 2001 may be, for example, a CPU or a system on chip (SoC), and controls functions of the application layer and other layers of the smart phone 2000. The memory 2002 includes an RAM and an ROM, and stores data and programs executed by the processor 2001. The storage device 2003 may include a storage medium, such as a semiconductor memory and a hard disk. The external connection interface 2004 is an interface for connecting an external device (such as a memory card and a universal serial bus (USB) device) to the smart phone 2000.

The camera 2006 includes an image sensor (such as a charge coupled device (CCD) and a complementary metal oxide semiconductor (CMOS)), and generates a captured image. The sensor 2007 may include a group of sensors, such as a measurement sensor, a gyroscope sensor, a geomagnetic sensor, and an acceleration sensor. The microphone 2008 converts sound inputted to the smart phone 2000 into an audio signal. The input device 2009 includes, for example, a touch sensor configured to detect a touch on a screen of the display device 2010, a keypad, a keyboard, a button, or a switch, and receives an operation or information inputted from a user. The display device 2010 includes a screen, such as a liquid crystal display (LCD) or an organic light emitting diode (OLED) display, and displays an output image of the smart phone 2000. The speaker 2011 converts the audio signal outputted from the smart phone 2000 into sound.

The radio communication interface 2012 supports any cellular communication scheme (such as LTE and LTE-Advanced), and performs wireless communications. The radio communication interface 2012 may generally include, for example, a BB processor 2013 and an RF circuit 2014. The BB processor 2013 may perform, for example, encoding/decoding, modulation/demodulation, and multiplexing/demultiplexing, and perform various types of signal processing for wireless communications. In addition, the RF circuit 2014 may include, for example, a mixer, a filter and an amplifier, and transmit and receive a wireless signal via the antenna 2016. The radio communication interface 2012 may be a chip module on which the BB processor 2013 and the RF circuit 2014 are integrated. As shown in FIG. 10, the radio communication interface 2012 may include multiple BB processors 2013 and multiple RF circuits 2014. Although FIG. 10 shows an example in which the radio communication interface 2012 includes multiple BB processors 2013 and multiple RF circuits 2014, the radio communication interface 2012 may include a single BB processor 2013 or a single RF circuit 2014.

In addition to the cellular communication scheme, the radio communication interface 2012 may support another type of wireless communication scheme, such as a short-range wireless communication scheme, a near field communication scheme, and a wireless local area network (LAN) scheme. In this case, the radio communication interface 2012 may include a BB processor 2013 and an RF circuit 2014 for each wireless communication scheme.

Each of the antenna switches 2015 switches a connection destination of the antenna 916 among multiple circuits (for example, circuits for different wireless communication schemes) included in the radio communication interface 2012.

Each of the antennas 2016 includes a single or multiple antenna elements (such as multiple antenna elements included in a MIMO antenna), and is configured for the radio communication interface 2012 to transmit and receive wireless signals. As shown in FIG. 10, the smart phone 2000 may include multiple antennas 2016. Although FIG. 10 shows an example in which the smart phone 2000 includes multiple antennas 2016, the smart phone 2000 may include a single antenna 2016.

In addition, the smart phone 2000 may include antenna(s) 2016 for each wireless communication scheme. In this case, the antenna switches 2015 may be omitted from the configuration of the smart phone 2000.

The processor 2001, the memory 2002, the storage device 2003, the external connection interface 2004, the camera 2006, the sensor 2007, the microphone 2008, the input device 2009, the display device 2010, the speaker 2011, the radio communication interface 2012, and the auxiliary controller 2019 are connected to each other via the bus 2017. The battery 2018 supplies power to each block of the smart phone 2000 as shown in FIG. 10 via a feeder line. The feeder line is partially shown as a dashed line in the figure. The auxiliary controller 2019 operates the least necessary function of the smart phone 2000 in a sleep mode, for example.

In the smart phone 2000 shown in FIG. 10, the communication unit in the electronic device 400 described with reference to FIG. 4 may be implemented through the radio wireless communication interface 2012 and the optional antenna 2016. At least part of the function of the decoding unit in the electronic device 400 may be implemented by the processor 2001 or the auxiliary controller 2019. For example, the processor 2001 or the auxiliary controller 2019 may implement all or part of the function of the decoding unit by executing instructions stored in the memory 2002 or the storage device 2003. Furthermore, the storage unit not shown in the electronic device 400 may be implemented through the memory 2002 or the storage device 2003.

### Second Application Example

FIG. 11 is a block diagram showing an example of a schematic configuration of an automobile navigation device 2120 to which the technology of the present disclosure is applicable. The automobile navigation device 2120 includes a processor 2121, a memory 2122, a global positioning system (GPS) module 2124, a sensor 2125, a data interface 2126, a content player 2127, a storage medium interface 2128, an input device 2129, a display device 2130, a speaker 2131, a radio communication interface 2133, one or more antenna switches 2136, one or more antennas 2137, and a battery 2138.

The processor 2121 may be, for example, a CPU or SoC, and controls the navigation function and other functions of the automobile navigation device 2120. The memory 2122 includes an RAM and an ROM, and stores data and programs executed by the processor 2121.

The GPS module 2124 measures a position (such as latitude, longitude, and altitude) of the automobile navigation device 2120 based on a GPS signal received from a GPS satellite. The sensor 2125 may include a group of sensors, such as a gyroscope sensor, a geomagnetic sensor, and an air pressure sensor. The data interface 2126 is connected to, for example, an in-vehicle network 2141 via a terminal not shown, and acquires data (such as vehicle speed data) generated by a vehicle.

The content player 2127 reproduces content stored in a storage medium (such as a CD and a DVD) inserted into the storage medium interface 2128. The input device 2129 includes, for example, a touch sensor configured to detect a touch on a screen of the display device 2130, a button, or a switch, and receives an operation or information inputted from a user. The display device 2130 includes a screen such as an LCD or OLED display, and displays an image of a navigation function or reproduced content. The speaker 2131 outputs a sound of the navigation function or reproduced content.

The radio communication interface 2133 supports any cellular communication scheme (such as LTE and LTE-Advanced), and performs wireless communications. The radio communication interface 2133 may generally include, for example, a BB processor 2134 and an RF circuit 2135. The BB processor 2134 may perform, for example, encoding/decoding, modulation/demodulation, and multiplexing/demultiplexing, and perform various types of signal processing for wireless communications. In addition, the RF circuit 2135 may include, for example, a mixer, a filter and an amplifier, and transmit and receive a wireless signal via the antenna 2137. The radio communication interface 2133 may be a chip module on which the BB processor 2134 and the RF circuit 2135 are integrated. As shown in FIG. 11, the radio communication interface 2133 may include multiple BB processors 2134 and multiple RF circuits 2135. Although FIG. 11 shows an example in which the radio communication interface 2133 includes multiple BB processors 2134 and multiple RF circuits 2135, the radio communication interface 2133 may include a single BB processor 2134 or a single RF circuit 2135.

In addition to the cellular communication scheme, the radio communication interface 2133 may support another type of wireless communication scheme, such as a short-range wireless communication scheme, a near field communication scheme, or a wireless LAN scheme. In this case, the radio communication interface 2133 may include a BB processor 2134 and an RF circuit 2135 for each wireless communication scheme.

Each of the antenna switches 2136 switches a connection destination of the antenna 2137 among multiple circuits (such as circuits for different wireless communication schemes) included in the radio communication interface 2133.

Each of the antennas 2137 includes a single or multiple antenna elements (such as multiple antenna elements included in a MIMO antenna), and is configured for the radio communication interface 2133 to transmit and receive wireless signals. As shown in FIG. 11, the automobile navigation device 2120 may include multiple antennas 2137. Although FIG. 11 shows an example in which the automobile navigation device 2120 includes multiple antennas 2137, the automobile navigation device 2120 may include a single antenna 2137.

In addition, the automobile navigation device 2120 may include antenna(s) 2137 for each wireless communication scheme. In this case, the antenna switches 2136 may be omitted from the configuration of the automobile navigation device 2120.

The battery 2138 supplies power to blocks of the automobile navigation device 2120 shown in FIG. 11 via a feeder line. The feeder line is partially shown as a dashed line in the figure. The battery 2138 accumulates electric power supplied from the vehicle.

In the vehicle navigation device 2120 shown in FIG. 11, the communication unit in the electronic device 400 described with reference to FIG. 4 may be implemented through the wireless communication interface 2133 and the optional antenna 2137. At least part of the function of the decoding unit in the electronic device 400 may be implemented by the processor 2121. For example, the processor 2121 may implement all or part of the functions of the decoding unit by executing instructions stored in the memory 2122. Furthermore, the storage unit not shown in the electronic device 400 may be implemented through the memory 2122.

The technology of the present disclosure may be implemented as an in-vehicle system (or vehicle) 2140 including the vehicle navigation device 2120, an in-vehicle network 2141, and one or more blocks of vehicle modules 2142. The vehicle modules 2142 generate vehicle data (such as vehicle speed, engine speed, and failure information), and outputs the generated data to the in-vehicle network 2141.

Preferred embodiments of the present disclosure are described above with reference to the drawings. However, the present disclosure is not limited to the above examples. Those skilled in the art can make various alternations and modifications within the scope of the appended claims. It should be understood that these alternations and modifications shall naturally fall within the technical scope of the present disclosure.

For example, units shown by a dotted line block in the functional block diagram shown in the drawings indicate that the functional units are optional in the corresponding device, and the optional functional units may be combined appropriately to achieve required functions.

For example, multiple functions implemented by a single unit in the above embodiments may be implemented by separate devices. Alternatively, multiple functions implemented by multiple units in the above embodiments may be implemented by separate devices respectively. In addition, one of the above functions may be implemented by multiple units. Such configurations are naturally included in the technical scope of the present disclosure.

In the specification, steps described in the flowchart include not only the processes performed chronologically as the described sequence, but also the processes performed in parallel or individually rather than chronologically. Furthermore, the steps performed chronologically may be performed in other order appropriately.

Furthermore, the present disclosure may have configurations as described below.
1. An electronic device, comprising
processing circuitry configured to:
scramble a first downlink control information, DCI, with a predefined terminal identifier, to indicate that a terminal device decodes a second DCI in a designated set of control channels; and
transmit the scrambled first DCI to the terminal device.
2. The electronic device according to configuration 1, wherein the second DCI comprises one or more DCIs to be transmitted after the first DCI.
3. The electronic device according to configuration 1, wherein the processing circuitry is further configured to: transmit, to the terminal device, indication information indicating the number of second DCIs, in a case where the number of second DCIs is more than 1.
4. The electronic device according to configuration 1, wherein
the first DCI comprises a wake-up indication, and the terminal identifier is a first terminal identifier for scrambling the first DCI comprising a wake-up indication to indicate that a subsequent second DCI is to be decoded in a designated set of control channels, or
the first DCI comprises no wake-up indication, and the terminal identifier is a second terminal identifier for scrambling the first DCI comprising no wake-up indication to indicate that a subsequent second DCI is to be decoded in a designated set of control channels.
5. The electronic device according to configuration 1, wherein the designated set of control channels satisfies one of a plurality of conditions:
a first condition that the control channels in the set have the same DCI format as the first DCI;
a second condition that the control channels in the set have the same aggregation level as a control channel carrying the first DCI;
a third condition that the control channels in the set have the same search space identifier as a control channel carrying the first DCI; or
a fourth condition that the control channels in the set have a scheduling DCI format.
6. The electronic device according to configuration 5, wherein the processing circuitry is further configured to transmit, to the terminal device, indication information designating one of the conditions.
7. The electronic device according to configuration 5, wherein the processing circuitry is further configured to: transmit first indication information and second indication information to the terminal device, wherein the first indication information designates one of the conditions that a set of control channels for decoding a second DCI subsequent to a first DCI comprising a wake-up indication meets, and the second indication information designates one of the conditions that a set of control channels for decoding a second DCI subsequent to a first DCI comprising no wake-up indication meets.
8. The electronic device according to configuration 7, wherein the first indication information designates the fourth condition, and the second indication information designates the first condition.
9. The electronic device according to configuration 3 or any one of claims 6 to 8, wherein the processing circuitry is further configured to: transmit the indication information through Radio Resource Control, RRC, signaling or Media Access Control Control Element, MAC CE, signaling.
10. The electronic device according to configuration 5, wherein
the first DCI comprises a wake-up indication, and the terminal identifier is a first terminal identifier for scrambling the first DCI comprising a wake-up indication to indicate that a subsequent second DCI is to be decoded in a set of control channels satisfying the fourth condition, or
the first DCI comprises no wake-up indication, and the terminal identifier is a first terminal identifier for scrambling the first DCI comprising no wake-up indication to indicate that a subsequent second DCI is to be decoded in a set of control channels satisfying the fourth condition.
11. An electronic device, comprising
processing circuitry configured to:
receive a first downlink control information DCI scrambled with a predefined terminal identifier; and
decode a second DCI in a designated set of control channels according to indication of the terminal identifier.
12. The electronic device according to configuration 11, wherein the second DCI comprises one or more DCIs to be transmitted after the first DCI.
13. The electronic device according to configuration 11, wherein the processing circuitry is further configured to receive indication information indicating the number of second DCIs, wherein the indication information indicates a number greater than one.
14. The electronic device according to configuration 11, wherein
the first DCI comprises a wake-up indication, and the terminal identifier is a first terminal identifier for scrambling the first DCI comprising a wake-up indication to indicate that a subsequent second DCI is to be decoded in a designated set of control channels, or
the first DCI comprises no wake-up indication, and the terminal identifier is a second terminal identifier for scrambling the first DCI comprising no wake-up indication to indicate that a subsequent second DCI is to be decoded in a designated set of control channels.
15. The electronic device according to configuration 11, wherein the designated set of control channels satisfies one of a plurality of conditions:
a first condition that the control channels in the set have the same DCI format as the first DCI;
a second condition that the control channels in the set have the same aggregation level as a control channel carrying the first DCI;
a third condition that the control channels in the set have the same search space identifier as a control channel carrying the first DCI; or
a fourth condition that the control channels in the set have a scheduling DCI format.
16. The electronic device according to configuration 15, wherein the processing circuitry is further configured to receive indication information designating one of the conditions.
17. The electronic device according to configuration 15, wherein the processing circuitry is further configured to: receive first indication information and second indication information, wherein the first indication information designates one of the conditions that a set of control channels for decoding a second DCI subsequent to a first DCI comprising a wake-up indication meets, and the second indication information designates one of the conditions that a set of control channels for decoding a second DCI subsequent to a first DCI comprising no wake-up indication meets.
18. The electronic device according to configuration 17, wherein the first indication information designates the fourth condition, and the second indication information designates the first condition.
19. The electronic device according to configuration 13 or any one of claims 16 to 18, wherein the processing circuitry is further configured to: receive the indication information through Radio Resource Control, RRC, signaling or Media Access Control Control Element, MAC CE, signaling.
20. The electronic device according to configuration 15, wherein
the first DCI comprises a wake-up indication, and the terminal identifier is a first terminal identifier for scrambling the first DCI comprising a wake-up indication to indicate that a subsequent second DCI is to be decoded in a set of control channels satisfying the fourth condition, or
the first DCI comprises no wake-up indication, and the terminal identifier is a first terminal identifier for scrambling the first DCI comprising no wake-up indication to indicate that a subsequent second DCI is to be decoded in a set of control channels satisfying the fourth condition.

### 21. a Method for Wireless Communication, Comprising:

scrambling a first downlink control information, DCI, with a predefined terminal identifier, to indicate that a terminal device decodes a second DCI in a designated set of control channels; and
transmitting the scrambled first DCI to the terminal device.
22. A method for wireless communication, comprising:
receiving a first downlink control information DCI scrambled with a predefined terminal identifier; and
decoding a second DCI in a designated set of control channels according to indication of the terminal identifier.
23. A non-transitory computer-readable storage medium storing executable instructions, wherein the executable instructions, when executed by a processor, cause the processor to perform the method for wireless communication according to configuration 21 or 22.

Although the embodiments of the present disclosure are described in detail above with reference to the accompanying drawings, it should be understood that the embodiments are only for illustrating the present disclosure and do not constitute a limitation of the present disclosure. For those skilled in the art, various modifications and changes can be made to the embodiments without departing from the essence and scope of the present disclosure. Therefore, the scope of the present disclosure is limited by only the appended claims and equivalents thereof.

1. An electronic device, comprising
at least one processor; and
at least one memory including computer program code, wherein the at least one memory and the computer program code are configured, with the at least one processor, to cause the electronic device to at least:
scramble a first downlink control information, DCI, with a predefined terminal identifier, to indicate that a terminal device decodes a second DCI in a designated set of control channels; and
transmit the scrambled first DCI to the terminal device.

2. The electronic device according to claim 1, wherein the second DCI comprises one or more DCIs to be transmitted after the first DCI.

3. The electronic device according to claim 1, wherein the at least one memory and the computer program code are configured, with the at least one processor, to further cause the electronic device to: transmit, to the terminal device, indication information indicating the number of second DCIs, in a case where the number of second DCIs is more than 1.

4. The electronic device according to claim 1, wherein
the first DCI comprises a wake-up indication, and the terminal identifier is a first terminal identifier for scrambling the first DCI comprising a wake-up indication to indicate that a subsequent second DCI is to be decoded in a designated set of control channels, or
the first DCI comprises no wake-up indication, and the terminal identifier is a second terminal identifier for scrambling the first DCI comprising no wake-up indication to indicate that a subsequent second DCI is to be decoded in a designated set of control channels.

5. The electronic device according to claim 1, wherein the designated set of control channels satisfies one of a plurality of conditions:
a first condition that the control channels in the set have the same DCI format as the first DCI;
a second condition that the control channels in the set have the same aggregation level as a control channel carrying the first DCI;
a third condition that the control channels in the set have the same search space identifier as a control channel carrying the first DCI; or
a fourth condition that the control channels in the set have a scheduling DCI format.

6. The electronic device according to claim 5, wherein the at least one memory and the computer program code are configured, with the at least one processor, to further cause the electronic device to transmit, to the terminal device, indication information designating one of the plurality of conditions.

7. The electronic device according to claim 5, wherein the at least one memory and the computer program code are configured, with the at least one processor, to further cause the electronic device to: transmit first indication information and second indication information to the terminal device, wherein the first indication information designates one of the plurality of conditions that a set of control channels for decoding a second DCI subsequent to a first DCI comprising a wake-up indication meets, and the second indication information designates one of the plurality of conditions that a set of control channels for decoding a second DCI subsequent to a first DCI comprising no wake-up indication meets.

8. The electronic device according to claim 7, wherein the first indication information designates the fourth condition, and the second indication information designates the first condition.

9. The electronic device according to claim 3, wherein the at least one memory and the computer program code are configured, with the at least one processor, to further cause the electronic device to: transmit the indication information through Radio Resource Control, RRC, signaling or Media Access Control Control Element, MAC CE, signaling.

10. The electronic device according to claim 5, wherein
the first DCI comprises a wake-up indication, and the terminal identifier is a first terminal identifier for scrambling the first DCI comprising a wake-up indication to indicate that a subsequent second DCI is to be decoded in a set of control channels satisfying the fourth condition, or
the first DCI comprises no wake-up indication, and the terminal identifier is a first terminal identifier for scrambling the first DCI comprising no wake-up indication to indicate that a subsequent second DCI is to be decoded in a set of control channels satisfying the fourth condition.

11. An electronic device, comprising
at least one processor; and
at least one memory including computer program code, wherein the at least one memory and the computer program code are configured, with the at least one processor, to cause the electronic device to at least:
receive a first downlink control information DCI scrambled with a predefined terminal identifier; and
decode a second DCI in a designated set of control channels according to indication of the terminal identifier.

12. The electronic device according to claim 11, wherein the second DCI comprises one or more DCIs to be transmitted after the first DCI.

13. The electronic device according to claim 11, wherein the at least one memory and the computer program code are configured. with the at least one processor, to further cause the electronic device to receive indication information indicating the number of second DCIs, wherein the indication information indicates a number greater than one.

14. The electronic device according to claim 11, wherein
the first DCI comprises a wake-up indication, and the terminal identifier is a first terminal identifier for scrambling the first DCI comprising a wake-up indication to indicate that a subsequent second DCI is to be decoded in a designated set of control channels, or
the first DCI comprises no wake-up indication, and the terminal identifier is a second terminal identifier for scrambling the first DCI comprising no wake-up indication to indicate that a subsequent second DCI is to be decoded in a designated set of control channels.

15. The electronic device according to claim 11, wherein the designated set of control channels satisfies one of a plurality of conditions:
a first condition that the control channels in the set have the same DCI format as the first DCI;
a second condition that the control channels in the set have the same aggregation level as a control channel carrying the first DCI;
a third condition that the control channels in the set have the same search space identifier as a control channel carrying the first DCI; or
a fourth condition that the control channels in the set have a scheduling DCI format.

16. The electronic device according to claim 15, wherein the at least one memory and the computer program code are configured, with the at least one processor, to further cause the electronic device to receive indication information designating one of the conditions.

17. The electronic device according to claim 15, wherein the at least one memory and the computer program code are configured, with the at least one processor, to further cause the electronic device to: receive first indication information and second indication information, wherein the first indication information designates one of the plurality of conditions that a set of control channels for decoding a second DCI subsequent to a first DCI comprising a wake-up indication meets, and the second indication information designates one of the plurality of conditions that a set of control channels for decoding a second DCI subsequent to a first DCI comprising no wake-up indication meets.

18. The electronic device according to claim 17, wherein the first indication information designates the fourth condition, and the second indication information designates the first condition.

19. (canceled)

20. The electronic device according to claim 15, wherein
the first DCI comprises a wake-up indication, and the terminal identifier is a first terminal identifier for scrambling the first DCI comprising a wake-up indication to indicate that a subsequent second DCI is to be decoded in a set of control channels satisfying the fourth condition, or
the first DCI comprises no wake-up indication, and the terminal identifier is a first terminal identifier for scrambling the first DCI comprising no wake-up indication to indicate that a subsequent second DCI is to be decoded in a set of control channels satisfying the fourth condition.

21. A method for wireless communication, comprising:
scrambling a first downlink control information, DCI, with a predefined terminal identifier, to indicate that a terminal device decodes a second DCI in a designated set of control channels; and
transmitting the scrambled first DCI to the terminal device.

22.-23. (canceled)
